(19) United States
(12) Patent Application Publication
(10) Pub. No.: US 2007/0135948 A1
(43) Pub. Date: Jun. 14, 2007

(54) Method and device for instructing a user

(75) Inventor: Jens Maase, Regensburg (DE)

Correspondence Address: LERNER GREENBERG STEMER LLP, P O BOX 2480, HOLLYWOOD, FL, 33022-2480, US

(73) Assignee: BSH Bosch und Siemens Hausgerate GmbH

(21) Appl. No.: 10/590,370

(22) PCT Filed: Feb. 1, 2005
(86) PCT No.: PCT/EP05/50433

§ 371 Date: Oct. 6, 2006

(30) Foreign Application Priority Data
Feb. 23, 2004 (DE) 10 2004 008 737.7

(51) Int. Cl. G05B 19/42

(52) U.S. Cl. 700/86

(57) ABSTRACT

A method instructs a user how to operate of an appliance. The method issues information via at least one output device for instructing the user with regard to the operation of the appliance. The method also identifies a control element of the device, which is to be taken into account by the user during the instruction of the latter by use of at least one marker element. A device is provided for carrying out the method.

The present invention relates to a method for instructing a user during the operation of an appliance, especially a domestic appliance, which comprises at least one control element, wherein the method comprises the step of issuing information via at least one audible and/or visual output device for instructing a user with regard to the operation of the appliance and a device for carrying out the method and the use of the device according to the invention in a domestic appliance for instructing a user during the operation of the domestic appliance.

The term “appliance” specified in the following description means any more or less complex, electrical or mechanical appliance which must be operated in some fashion by a human user. In this case, domestic appliances are particularly but not exclusively intended, such as a coffee machine, a washing machine or a cooker.

In general, operating instructions are usually supplied as a book when purchasing the appliance. The operating instructions are not only necessary when the appliance is first operated until the user is familiar with using the appliance but also later when one-off or rarely recurring operations are to be carried out on the appliance, such as maintenance, descaling or cleaning the appliance. However, it frequently arises that these operating instructions are not found when required because they have been moved or even mislaid.

To avoid these deficiencies it has been proposed to provide the appliance with built-in operating instructions. Such a solution is provided, for example, in WO 99/30425 whereby stored operating instructions can be retrieved in the appliance and output via an output device. In this case, it is provided that the operating instructions can be retrieved from a non-volatile memory in the appliance and can be displayed on a screen.

The operating instructions of more complex appliances usually include a picture portion and a number of text sections allocated to this picture portion. The text explaining the picture is frequently arranged in several sections below or next to each picture. The picture usually shows a certain control element of the appliance while the relevant text section provides detailed information relating to the operation of the control element. In this case, the user of the operating instructions frequently perceives it to be particularly disturbing to search anew for the location described or the control element described in the appliance for each picture and for each text section in order to appropriately actuate the control element according to the explanation given in the text. The term “control element” as used herein is to be understood as any input devices such as a push button or switch but also those devices which are in any functional relationship to the appliance and which must be actuated as required by the user. For example, this would also include a toner cartridge for a printer or copier which must be periodically exchanged by the user or a container for storing service fluids which need to be topped up as required by the user.

Accordingly, the technical object of the present invention is to instruct a user during the operation of an appliance of the type specified initially and a corresponding device by which means it is easier to operate the appliance.

This object is achieved in a method of the type specified initially according to the invention by the process step of identifying a control element of the appliance to be take into account during the instruction by the user by means of at least one visual and/or audible marker element.

The object forming the basis of the present invention is further achieved by a device for carrying out the method specified hereinbefore, wherein the device has at least one output device for the audible and/or visual output of information for instructing the user during the operation of the appliance and wherein the device is characterized in that the device further has at least one marker element which optically and/or acoustically identifies a control element of the appliance to be taken into account by the user during the instruction.

The use of the device according to the invention in a household appliance for instructing a user during the operation of the household appliance is further provided as a solution of the usage object forming the basis of the present invention.

The advantages of the invention are that it is possible to achieve a very effective method for facilitating the control of complex appliances, especially domestic appliances, which is simple to implement. It is provided that information relating to the control of the appliance is output on an output device, this output being either acoustic, for example, via an announcement, or optical, for example, by displaying the information on an LCD display or a similar device. This information contains instructions for operating the appliance.

The term “information used here” means any data which are used to instruct the user how to operate the appliance to call up a certain function and cause the appliance to execute this function.

It is advantageously provided that in addition to issuing information via the output device, the control elements of the appliance to be taken into account by the user during the instruction are further identified. This identification is made by means of visual and/or audible marker elements. The term “marker elements” should be understood as all devices which clearly mark the respective control element of the appliance for the user. For example, LEDs or lamps but also sound sources can be used for identification.

While the user is given a more or less detailed technical description via the output device regarding the technical sequences during the operation of the appliance, the marker elements advantageously in the form of light signs or sound signal sources serve as a further aid. While the user is instructed on the output device by text on a display or by speech output, the part of the appliance just described in marked optically or acoustically or by a combination of the two via the process step of identifying the control element to be take into account by the user via the at least one marker element. Thus, it is further feasible that the marker elements applied to the respective control elements of the appliance to be controlled, can have various symbols to represent the type of action to be performed by the user. Consequently, the location of the action and also the type of action is illustrated by symbols.

A possibility for carrying out the method described previously is provided with the device according to the invention. In this case, it is provided that the device comprises marker elements which identify the control elements to be taken into account by the user during the instruction. These marker elements are advantageously located in the immediate vicinity of the control element or they are integrated in the control element itself. In a particularly preferred embodiment, the marker element is provided with a corresponding own intelligence and is communicatively connected to the relevant control element so that the marker elements for example are automatically deactivated after the relevant marker element has been actuated by the user. It is further feasible that the marker element is additionally or instead connected to suitable sensors, these sensors displaying the operating state of the control element or the entire appliance to the marker element which then reacts accordingly.

Preferred further developments of the invention are specified with regard to the method in dependent claims 2-5 and with regard to the device in dependent claims 7-12.

Thus, it is preferably provided for the method that the instruction of the user during operation of the appliance takes place in steps, wherein each instruction step corresponds to an information block consisting of a part or the entirety of the information which can be output. By dividing the information into individual information blocks, it is advantageously achieved that respectively one part of the information required to instruct the user can be retrieved. This can simplify or eliminate the scrolling or leafing through the possibly very comprehensive information for the operating instructions of the appliance which is possibly required otherwise. In this embodiment, it can preferably be provided that a part of the operating instructions is retrieved by applying the operating voltage to the appliance. In this case, it is feasible that this part of the operating instructions contains introductory information, for example, which informs the user about the most important functions of the appliance when first starting up and optionally indicates further information in the operating instructions. In addition, this part of the operating instructions but also like other parts, can be retrieved by an input via a corresponding input device or via a control element of the appliance. Naturally, other embodiments are also feasible here.

In a particularly preferred further development of the embodiment of the method according to the invention specified in the last paragraph, it is provided that the control element to be taken into account by the user during the instruction is identified in temporal synchronization with the information block. This allows the relevant control parts treated or described simultaneously on the output device to be marked in a particularly understandable and user-friendly manner. In other words, this means that the display of the valid information block is always activated on the output device by displaying, for example, an immediately following information block if the user has actuated the control element identified by means of the relevant marker element.

In order to allow a context-dependent selection from the operating instructions so that the user receives the respectively relevant part of the operating instructions, it is particularly advantageously provided that the output of information for instructing the user takes place in steps depending on the actuation of the identified control element by the user. In this case, it is feasible for example that further parts of the operating instructions are output by repeatedly actuating the identified control element. However, it would also be feasible that a part of the operating instructions is output by actuating the predetermined or identified control element and then actuating a further, optionally likewise identified, control element, where part of the operating instructions relates to the further control element. The selection from the operating instructions is then additionally facilitated if the user could obtain information independently of the respective operating state of the appliance.

For the method it is further preferably provided that the output of information for instructing the user takes place depending on the respective operating state of the appliance. This embodiment is a particularly effective method for instructing a user in the operation of the appliance in a user-friendly manner. It is thus possible for the user to particularly rapidly set or call up an operating state or an operation of the appliance.

As an advantageous further development for the device according to the invention, it is provided that the device further comprises a memory connected to the output device for storing information. This embodiment is particularly preferred since digital memories are becoming increasingly inexpensive and compact. In a particularly advantageous embodiment it is provided that the appliance can be connected to a transmission device, for example, to a mobile radio network or to a usual communication network, including the Internet, so that a possibly updated or valid operating instruction for the relevant appliance can be downloaded from the Internet for example into the memory via the transmission device. Furthermore, an incorrect operating instruction originally provided can be modified in the memory if required. For this purpose, in addition to the memory, it may be necessary for the appliance to have a processor for controlling the necessary operations.

In order to allow the information necessary with regard to the operating instruction of the appliance to be displayed as clearly as possible, it is particularly preferably provided that not all the information stored in the memory is downloaded simultaneously from the memory and stored but only information blocks directly related to the operation of the appliance desired by the user.

In a particularly preferred embodiment of the device according to the invention, it is thus provided that the at least one information block output on the output device corresponds to a respective operating state of the appliance. It is thereby achieved that the user automatically obtains a context-dependent selection from the information and thus the respectively relevant part of the information.

In a particularly preferred realization it is provided that by actuating the identified control element a further information block is output on the output device and that the further information block corresponds to the respective operating state of the appliance and a next instruction step.

As an advantageous further development of the device according to the invention, it is further provided that at least one output device and at least one marker element are executed together in an integrated form as a component. For example, it is feasible that this component is a display on which the information is displayed in the form of a text, thee displays being arranged on the respective control elements to be taken into account by the user and, for example, changing their brightness or their color to identify the control element. In this embodiment, the two separate information means—output device and marker element—are advantageously combined to ensure that the attention of the appliance user is immediately drawn to the control elements to be controlled. On examining these control elements, the user then obtains further information, for example, by means of the displays integrated in the component.

Further advantages and functionalities of the invention will become clear from the following description of the preferred exemplary embodiments of the invention with reference to the plurality of figures and in the following description.

In the figures:

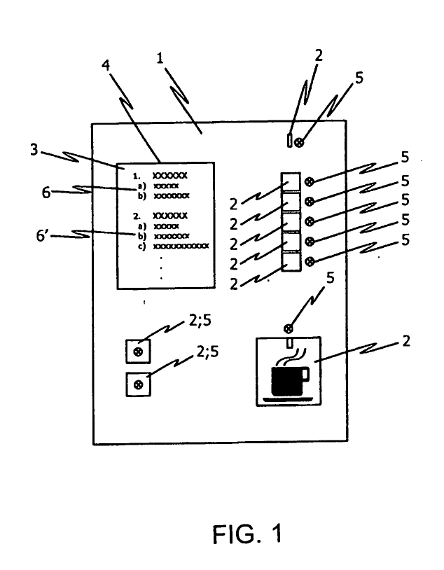

FIG. 1 is a schematic diagram of a domestic appliance in which the device according to the invention for instructing a user in the operation of the appliance is integrated;

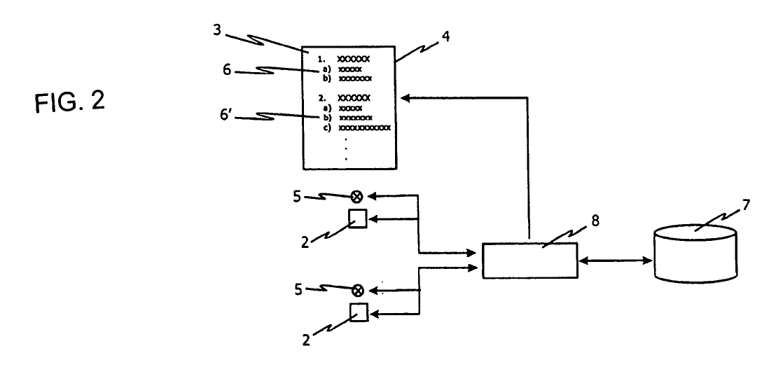

FIG. 2 is a block diagram showing schematically the functional components of the embodiment of the device according to the invention shown in FIG. 1; and

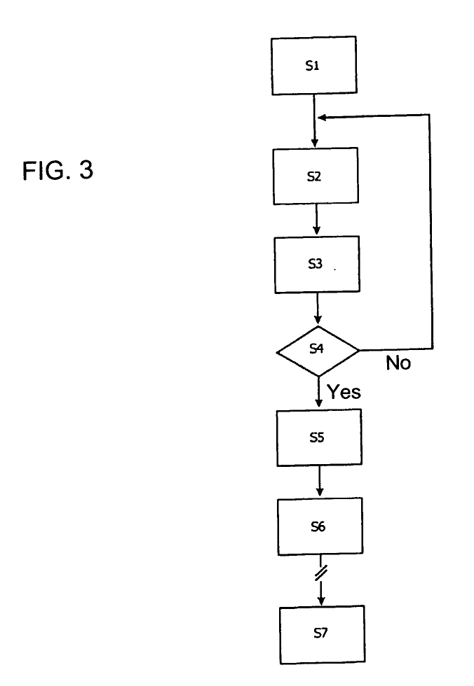

FIG. 3 is a flow diagram showing the process steps of a preferred embodiment of the method according to the invention for instructing a user in the operation of the appliance shown in FIG. 1.

FIG. 1 is a schematic diagram of a domestic appliance 1 in which the device according to the invention for instructing a user in the operation of the appliance 1 is integrated. In the embodiment shown, the appliance 1 is a large coffee machine comprising a series of control elements 2 for operating the appliance 1. These control elements 2 can be selection buttons with which the user can select the type of hot drink (cappuccino, coffee, coffee with sugar et.). The term “control element” also includes, for example, the coin insertion and also devices provided for maintenance of the appliance 1. Control elements provided for maintenance can, for example, comprise a filling opening for a descaler, a residue box to be emptied or a similar device.

According to the invention, as shown in FIG. 1, each control element 2 is provided with a marker element 5, and this can either be a visual and/or an audible signal emitter. In the preferred embodiment shown in FIG. 1 the marker elements are illuminating means, for example, LEDs. Naturally, however it is also feasible to use at least some of the marker elements as audible signal emitters. Also it is not necessary for an individual separate marker element 5 to be allocated to each control element 2 of the appliance 1 equipped with the device according to the invention.

As shown in FIG. 1, the device according to the invention for instructing the user in the operation of the appliance 1, implemented in the coffee machine 1, also has an output device 4. In the embodiment shown the output device 4 is a liquid crystal display unit on which information 3 for instructing the user in the operation of the appliance 1 is output, However, the execution of the output device 4 as a display element is not limited hereto but can, for example, also be a device for the audible output of information 3. Information 3 relating to the operation of the appliance 1 are output on the output device 4. This information contains instructions for operating the appliance 1. This information 3 comprises those data which instruct the user how to operate the appliance 1 in order, for example, to call up a certain function of the appliance 1 and make the appliance 1 execute this function. In the preferred embodiment shown in FIG. 1 it is provided that the information 3 is divided into individual information blocks 6, each information block 6 corresponding to an instruction step for operating the appliance 1.

The operating mode of the device according to the invention is explained in detail hereinafter. In a preferred embodiment it is provided that a starting information block 6 is displayed on the output device 4 as soon as the user has actuated any control element 2 of the appliance 1. This initial information block 6 can, for example, display an overview of the contents which informs the user as to the different functionalities of the appliance 1. Naturally, it is also feasible that a starting information block 6 is displayed permanently on the output device 4 as long as the appliance 1 is in a stand-by or rest state. It is also possible that this starting information block 6 is activated in response to inserting coin into a corresponding coin slot of the appliance 1. Starting from the situation where the output device 4 displays an information block 6 informing the user as to the various options, in a preferred embodiment of the invention the user will then be requested to select an option by scrolling or leafing through the individual menu items displayed on the output device 4 by possibly repeatedly actuating a certain control element 2 and thereby selecting a desired menu item by actuating a further control element 2. At this point, it is also feasible that the control element 2 for selecting the menu item is the same control element 2 used by the user to scroll or leaf through the individual menu items. In this case, for example, a correspondingly longer depression of the control element 2 could bring about the selection.

According to the invention, it is now provided that respectively at least one marker element 5 is arranged next to the control element, which identifies the control element 2 to be actuated to the user. This identification can be made by visual and/or audible signaling. Thus, it is feasible that at the same time as displaying the starting information block 6 on the output device 4, a corresponding marker element 5 assigned thereto identifies the control element 2 which the user must actuate to be able to scroll or leaf through the menu selection displayed on the output device and select a specific option.

It is subsequently assumed that the user has selected a certain option which calls up and initiates an operating sequence of the appliance 1 desired by the user. It is further assumed that the operating sequence which has been called up requires further actions to be actively carried out by the user. Descaling of the household appliance 1 could serve as a specific example of an operating sequence here, where the user has to change a scale filter for example in the further sequence and call up a cleaning run of the appliance 1. Starting from this situation, after the user has selected a certain functionality in the start information block 6, a further information block 6′ is output on the output device, this further information block 6′ corresponding to a respective operating state of the appliance 1 and a next instruction step. Together with the output of the further information block 6′, a marker element 5 identifies the respective position of the appliance 1 or the corresponding control element 2 of the appliance 1 that is to be actuated by the user in this instruction step. In this case, the further information block 6′ shown in the output device delivers further details relating to the respective instruction step or operating state of the appliance 1.

After the user has actuated the control element 2 identified by the corresponding marker element 5 in the relevant instruction step, a further information block 6′ illustrating the following instruction step is automatically output on the output device 4′. At the same time as this output, the control element 2 of the appliance 1 to be actuated in this instruction step is again identified by means of the relevant marker element 5. This simultaneous identification of the control element 2 to be actuated by the user with the output of the relevant information block 6′ on the output device 4 takes place until the operation cycle of the appliance 1 initially called up by the user has been completed.

In a particularly preferred embodiment it is provided that the identification of the control element 2 to be taken into account by the user during the instruction is synchronized in time with the information block 6, 6′. However, it would also be feasible for the synchronization to be based on the respective operating state of the appliance 1.

In a further embodiment (not shown), the output device 4 and the respective marker elements 5 are embodied together in integrated form as a component. For example, it is feasible that adjacent to each individual control element 2 of the appliance 1 is an LCD display device which displays respectively that information block 6, 6′ which corresponds to an instruction step for the operation of the relevant control element 1. For example, it is possible that the brightness of the display is varied to appropriately identify the relevant control element 2 for the user. As a result, the attention of the user is drawn to this control element 2 whereby the user at the same time absorbs further details relating to the respective instruction step on the display device (for example, thus flashing) arranged next to the respective control element 2.

Furthermore, it is feasible that the marker elements 5 are integrated in the respective control elements 2. Keypads which can light up appropriately could possibly be used as control elements 2 here. Naturally, other embodiments are also feasible.

FIG. 2 is a block diagram showing schematically the functional components of the embodiment of the device according to the invention shown in FIG. 1. In this case, it is provided that a controller 8 takes over the coordination between the output device 4, the control elements 2 and the marker elements 5. Each controller 8 is, for example, a processor which is well known from the prior art and will not be described in detail here.

Starting from the situation that a user initially actuates a control element 2, a signal is transmitted from this control element 2 to the controller 8 in response to which the controller 8 outputs the initial or starting information block 6 on the display device 4. Depending on the actuation of a corresponding control element 2, the controller 8 outputs a corresponding information block 6 or 6′ via the output device 4. For this purpose it is provided that the controller 8 has access to a memory 7 in which the respective information 3 is stored. Depending on the operating state of the appliance 1 and depending on the information block 6 respectively shown on the output device 4, the respective marker element 5 is triggered via the controller 8, identifying for the user the control element 2 to be actuated in the information block 6 which is presently called up.

It is particularly preferably provided that the device according to the invention further comprises a terminal or a connection for a data or information input from outside. In the embodiment shown in FIG. 2, this terminal is not shown explicitly however. Thus, it is feasible that information stored in the memory 7 relating to the operation of the appliance 1 can be updated or replaced via this terminal from outside, for example, via the Internet or an external data carrier. This allows the appliance 1 to be significantly more user-friendly when instructing the user for confirmation of the appliance 1.

FIG. 3 is a flow diagram showing the process steps of an embodiment of the method according to the invention for instructing a user in the operation of the appliance 1 shown in FIG. 1. The operating sequence shown in FIG. 3 is to be understood merely as an example. This involves a cleaning sequence of the coffee machine 1 shown in FIG. 1.

After the user has selected the “cleaning” option on the output device 4 by actuating a corresponding control element 2 (process step S1), an information block 6 next appears on the output device 4 which instructs the user either optically or acoustically regarding the first instruction step (process step S2). In the embodiment shown the user is requested to remove a coffee dregs container which represents a control element 2 in the sense of the present invention. At the same time, a marker element 5, for example, a lamp, identifies the door which the user has to open to reach the coffee dregs container (process step S3). In this case, it is provided that the door has a corresponding sensor which signals the state of the door (open or closed).

If the sensor signals that the door is not opened (“no”), the process returns to process step S2 so that an information block 6 again appears on the output device 4 which instructs the user either optically or acoustically with regard to the first instruction step (process step S2). The user is again requested to remove the coffee dregs container. At the same time, the marker element 5 again identifies the door which the user has to open to reach the coffee dregs container (process step S3).

If the sensor now signals that the user has opened the door (“yes”), the process goes to the next process steps resulting from the display of a further information block 6′ on the display device 4 (process step S5) and from the identification of the control element 2 to be actuated next in this instruction step (process step 6). According to the exemplary embodiment shown in FIG. 3, the drip tray must be removed in the next instruction step. For this reason a corresponding message is shown as information block 6′ on the output device 4 (process step S5) while the marker element 5 assigned to the drip tray at the same time identifies the drip tray (process step S6). A sensor is also provided here to signal the appropriate state of the drip tray.

As soon as the user has removed the drip tray, the process goes over to the next step. This principle is followed until the operation of the appliance 1 which was originally called up has been completed (process step S7).

### REFERENCE LIST

1 Appliance
2 Control element
3 Information
4 Output device
5 Marker element
6, 6′ Information block
7 Memory
8 Controller

1-11. (canceled)

14. A method for instructing a user during an operation of an appliance, the appliance having at least one control element, at least one marker element, and an output device being an audible and/or visual output device, which comprises the steps of:
outputting information for instructing the user with regard to the operation of the appliance via the output device, the information describing a control element to be actuated by the user; and
identifying the control element described with the marker element during the outputting of the information.

15. The method according to claim 14, which further comprises performing the instructing of the user during operation of the appliance in steps, wherein each instruction step corresponds to an information block containing at least a part or an entirety of the information to be output.

16. The method according to claim 15, which further comprises identifying the control element to be taken into account by the user during the instructing in temporal synchronization with the information block.

17. The method according to claim 15, which further comprises performing the outputting of the information for instructing the user in steps depending on an actuation of an identified control element by the user.

18. The method according to claim 14, which further comprises performing the outputting of the information for instructing the user in dependence on a respective operating state of the appliance.

19. An appliance, comprising:
at least one control element being in functional relationship to the appliance;
at least one output device for providing an audible and/or visual output of information for instructing a user during an operation of the appliance, the information describing which said control element to be actuated by the user; and
at least one marker element for optically identifying said control element described during an output of the information.

20. The appliance according to claim 19, further comprising a memory connected to said output device for storing the information.

21. The appliance according to claim 20, wherein the information is formed from information blocks and that each individual information block corresponds to an instruction step for an operation of the appliance.

22. The appliance according to claim 21, wherein a retrieval of at least one information block from said memory and the output of a retrieved information block to said output device is accomplished by a predetermined control element.

23. The appliance according to claim 22, wherein the at least one information block output at said output device corresponds to a respective operating state of the appliance.

24. The device according to 21, wherein by actuating an identified control element a further information block is output on said output device and that the further information block corresponds to a respective operating state of the appliance and a next instruction step.

25. The device according to 19, wherein the appliance is a domestic appliance.
